(19) United States
(12) Patent Application Publication
(10) Pub. No.: US 2025/0383493 A1
(43) Pub. Date: Dec. 18, 2025

(54) BACKLIGHT MODULE

(71) Applicant: DARWIN PRECISIONS CORPORATION, Hsinchu County (TW)

(72) Inventors: Li-Yu Chang, Hsinchu County (TW); HUI-YING CHIANG, Hsinchu County (TW)

(21) Appl. No.: 19/026,666

(22) Filed: Jan. 17, 2025

(30) Foreign Application Priority Data
Jun. 14, 2024 (TW) 113122214

(51) Int. Cl. F21V 8/00

(52) U.S. Cl. CPC G02B 6/0073; G02B 6/0016; G02B 6/0065

(57) ABSTRACT

The invention provides a backlight module including a light guide plate and a light source. The light guide plate has a light-incident surface and a light exit surface which is adjacent to the light-incident surface. The light exit surface is provided with multiple columnar structures, and the multiple columnar structures are provided with multiple point structures. The multiple point structures are located within a distribution range of the light exit surface. In a length direction intersecting the light-incident surface, the distribution range extends a predetermined length from the light-incident surface in a direction away from the light-incident surface. The distribution length accounts for 0.5% to 1.5% of a total length of the light guide plate along the length direction. The light source is arranged opposite the light-incident surface. This backlight module can provide a surface light source with uniform brightness.

### FIELD OF THE INVENTION

The invention relates to a light source module, and more particularly to a backlight module.

### BACKGROUND OF THE INVENTION

The backlight module is used to provide a surface light source with uniform brightness for the liquid crystal display panel. The backlight modules can be divided into edge-lit backlight modules and direct-lit backlight modules based on the placement position of the light source, where the light source of the edge-lit backlight module is arranged on the side surface of the light guide plate. According to the prior art, a plurality of light-emitting diodes are used as the light source, but this easily causes the backlight module to form alternating bright and dark stripes on the side close to the light source. Moreover, as consumer preferences trend towards narrow bezels, the distance between the light guide plate and the light source becomes smaller, making the alternating bright and dark stripes more noticeable. Therefore, those in the related industries are eager to resolve the quality issue of the backlight module.

### SUMMARY OF THE INVENTION

The invention provides a backlight module that can provide a surface light source with uniform brightness.

To achieve one or some or all of the above objectives or other objectives, an embodiment of the invention provides a backlight module, including a light guide plate and a light source. The light guide plate has a light-incident surface and a light exit surface that are adjacent to each other. The light exit surface is provided with a plurality of columnar structures, the plurality of columnar structures is provided with a plurality of point structures, and the plurality of point structures is located in a distribution range of the light exit surface. In a length direction intersecting the light-incident surface, the distribution range extends a predetermined length from the light-incident surface in a direction away from the light-incident surface, and the predetermined length accounts for 0.5% to 1.5% of a total length of the light guide plate along the length direction. The light source is arranged opposite the light-incident surface.

In an embodiment of the invention, the plurality of columnar structures extends from the light-incident surface to another surface opposite to the light-incident surface.

In an embodiment of the invention, the plurality of columnar structures are arranged in the distribution range and do not extend out of the distribution range.

In an embodiment of the invention, an extension direction of the plurality of columnar structures is perpendicular to the light-incident surface.

In an embodiment of the invention, the light exit surface has two opposite side edges connected to the light-incident surface, and the distribution range extends from one of the two side edges to the other of the two side edges.

In an embodiment of the invention, the light source includes a plurality of light-emitting diodes, the distribution range includes a plurality of unconnected sub-regions, and the plurality of sub-regions respectively corresponds to the plurality of light-emitting diodes. In a width direction parallel to the light exit surface and the light-incident surface, a width of each of the sub-regions is more than 1.3 times a width of a light-emitting surface of each of the light-emitting diodes.

In an embodiment of the invention, the point structures are distributed regularly or randomly.

In an embodiment of the invention, the columnar structures have the same or different widths.

In an embodiment of the invention, vertical projections of the plurality of point structures on the light exit surface are in the shape of at least one of a circle or an ellipse.

In an embodiment of the invention, a material of the light guide plate includes polymethylmethacrylate, polycarbonate, MS resin, or glass.

In the invention, a light guide plate, which has a light exit surface provided with a plurality of columnar structures and a plurality of point structures, is used, the plurality of point structures being provided on the plurality of columnar structures. In the length direction, the predetermined length of the distribution range of the plurality point structures accounts for 0.5% to 1.5% of the total length of the light guide plate, and thus the backlight module can provide a surface light source with uniform brightness.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic top view of a backlight module according to an embodiment of the invention;

FIG. 2 is a schematic side view of the backlight module according to an embodiment of the invention;

FIG. 3 is a schematic top view of the backlight module according to another embodiment of the invention;

FIG. 4 is a schematic top view of the backlight module according to another embodiment of the invention;

FIG. 5 is a schematic distribution diagram of point structures according to another embodiment of the invention;

FIG. 6 is a schematic distribution diagram of the point structures according to another embodiment of the invention; and

FIG. 7 is a schematic distribution diagram of columnar structures according to another embodiment of the invention.

### DETAILED DESCRIPTION OF PREFERRED EMBODIMENTS

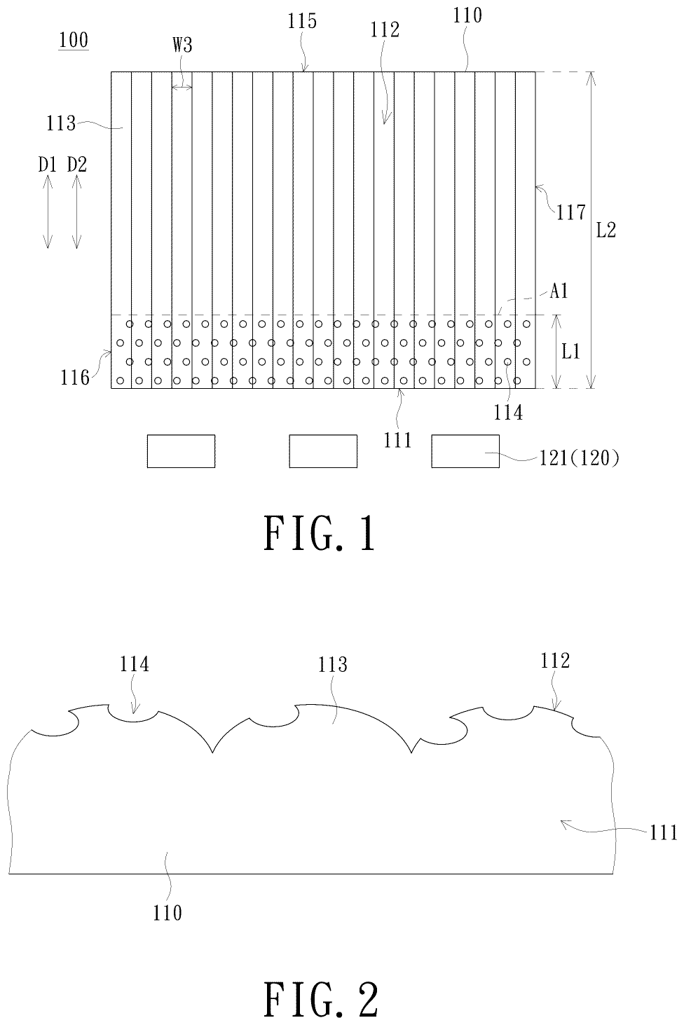

FIG. 1 is a schematic top view of a backlight module according to an embodiment of the invention. FIG. 2 is a schematic side view of the backlight module according to an embodiment of the invention. Referring to FIGS. 1 and 2, this embodiment provides a backlight module 100, including a light guide plate 110 and a light source 120. The light guide plate 110 has a light-incident surface 111 and a light exit surface 112 that are adjacent to each other, and the light source 120 is arranged opposite the light-incident surface 111. Specifically, the backlight module 100 of this embodiment is, for example, an edge-lit backlight module 100, with the light source 120 arranged on one side of the light guide plate 110. In other words, the backlight module 100 is, for example, a single-side edge-lit backlight module 100, which, however, is not specifically limited in the invention. In another embodiment, the light source 120 may also be arranged on two sides of the light guide plate 110. In other words, the backlight module 100 may be, for example, a double-side edge-lit backlight module 100 (not shown in the figure). The light source 120 of this embodiment, for example, includes a plurality of light-emitting diodes 121, taking three light-emitting diodes 121 as an example. The invention does not specifically limit the type of the light source 120 and the number of light-emitting diodes 121. In addition, the light source 120 and the light-incident surface 111 of this embodiment, for example, have a spacing, which, however, is not specifically limited in the invention. In another embodiment, there may be no spacing between the light source 120 and the light-incident surface 111, that is, the light source 120 is in contact with the light-incident surface 111 (not shown in the figure).

The material of the light guide plate 110 in this embodiment is, for example, a transparent material such as polymethylmethacrylate (polymethylmethacrylate, PMMA), polycarbonate (polycarbonate, PC), MS resin, or glass, which is not specifically limited in the invention. The MS resin is, for example, a copolymer of methylmethacrylate (methylmethacrylate, MMA) and styrene (styrene).

The light exit surface 112 of this embodiment is provided with a plurality of columnar structures 113, and a plurality of point structures 114 are provided on the plurality of columnar structures 113. The point structures 114 are located within the distribution range Al of the light exit surface 112. In this embodiment, because the columnar structures 113 on the light exit surface 112 are provided with point structures 114, the surface light source of the backlight module 100 can have a more uniform brightness. Furthermore, the distribution range Al of the point structures 114 in this embodiment on the light exit surface 112 is on the side close to the light-incident surface 111, allowing for more uniform brightness on the side of the backlight module 100 close to the light source 120, and avoiding the formation of alternating bright and dark stripes, thereby improving the quality of the backlight module 100. The extension direction D2 of the columnar structures 113 in this embodiment is, for example, perpendicular to the light-incident surface 111, which, however, is not specifically limited in the invention.

In addition, because the plurality of point structures 114 are provided on the plurality of columnar structures 113 in this embodiment, the light-incident surface 111 of the light guide plate 110 may be a flat surface, thereby helping to avoid the alternating bright and dark stripes from becoming obvious and/or complex. However, the invention is not limited thereto and can be adjusted as needed, for example, by setting microstructures on the light-incident surface 111.

In the length direction D1 intersecting the light-incident surface 111, the distribution range A1 of the point structures 114 in this embodiment extends a predetermined length L1 from the light-incident surface 111 in a direction away from the light-incident surface 111, and the predetermined length L1 accounts for 0.5% to 1.5% of the total length L2 of the light guide plate 110 along the length direction D1. The length direction D1 of this embodiment is, for example, perpendicular to the light-incident surface 111. It is worth mentioning that the predetermined length L1 in this embodiment of the invention only accounts for 0.5% to 1.5% of the total length L2, which can avoid excessive light energy consumption near the light source 120 and reduce the light source transmission to places far from the light source 120. In other words, this embodiment can avoid the issue where a position of the backlight module 100 near the light source 120 is brighter and a position away from the light source 120 is dimmer. Therefore, in this embodiment, the predetermined length L1 being arranged within a certain range helps to provide the backlight module 100 with a surface light source with more uniform brightness.

In this embodiment, a light guide plate 110, which has a light exit surface 112 provided with a plurality of columnar structures 113 and a plurality of point structures 114, is adopted, the plurality of point structures 114 is provided on the plurality of columnar structures 113, and the predetermined length L1 of the distribution range A1 of the plurality point structures 114 accounts for 0.5% to 1.5% of the total length L2 of the light guide plate 110 in the length direction D1. Thus, the backlight module 100 can provide a surface light source with uniform brightness.

For example, in an embodiment of the invention, the long side and short side of the light guide plate 110 are, for example, 530 mm and 300 mm respectively, and the light source 120 is, for example, arranged on the long side of the light guide plate 110. The predetermined length L1 extends, for example, 2 mm from the light-incident surface 111 along the length direction D1 perpendicular to the light-incident surface 111, meaning that the predetermined length L1 accounts for, for example, 0.67% of the total length L2 (which should be the length of the short side of the light guide plate 110) of the light guide plate 110. In another embodiment of the invention, the long side and short side of the light guide plate 110 are, for example, 500 mm and 235 mm respectively, and the light source 120 is, for example, arranged on the long side of the light guide plate 110. The predetermined length L1 extends, for example, 2 mm from the light-incident surface 111 along the length direction D1 perpendicular to the light-incident surface 111, meaning that the predetermined length L1 accounts for, for example, 0.85% of the total length L2 of the light guide plate 110. In another embodiment of the invention, the long side of the light guide plate 110 is, for example, 150 mm, and the light source 120 is, for example, arranged on the short side of the light guide plate 110. The predetermined length L1 extends, for example, 2 mm from the light-incident surface 111 along the length direction D1 perpendicular to the light-incident surface 111, meaning that the predetermined length L1 accounts for, for example, 1.33% of the total length L2 (which should be the length of the long side of the light guide plate 110) of the light guide plate 110. The above are merely examples and the predetermined length L1 can be adjusted based on actual needs. For example, the predetermined length L1 is reduced to be greater than 0 mm and less than 2 mm.

In this embodiment, the columnar structure 113 is, for example, cylindrical, as shown in FIG. 2, which, however, is not specifically limited in the invention. In another embodiment, the columnar structure 113 may be of another shape, for example, being prismatic (not shown in the figure). The point structure 114 in this embodiment is, for example, a structure recessing from the surface of the columnar structure 113, which, however, is not specifically limited in the invention. In another embodiment, the point structure 114 may also be a structure (not shown in the figure) protruding from the surface of the columnar structure 113. In this embodiment, the material of the columnar structure 113, for example, is the same as that of the light guide plate 110, but the invention is not limited thereto. In this embodiment, the material of the point structure 114, for example, is the same as that of the light guide plate 110, or it may be a material that can adhere to the light guide plate 110, such as UV-curable glue or ink, which is also not specifically limited in the invention.

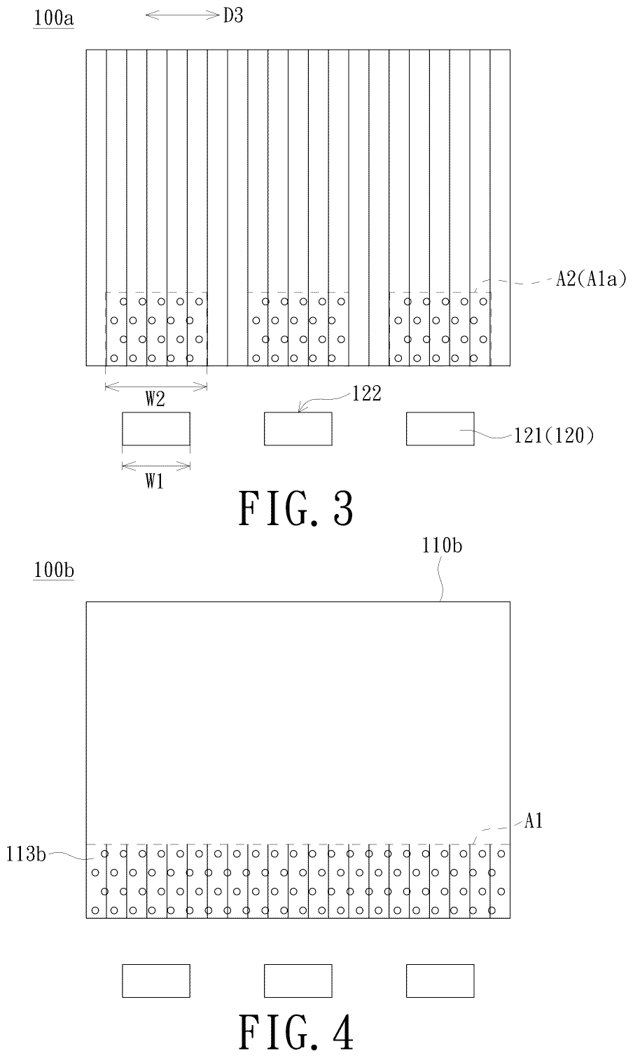

Refer to FIG. 1. In this embodiment, the light exit surface 112 of the light guide plate 110 has two opposite side edges connected to the light-incident surface 111. The distribution range A1, for example, extends from one of the two side edges to the other of the two side edges. Specifically, the light exit surface 112 has, for example, side edges 116 and 117 that are opposite to each other and both connected to the light-incident surface 111. The distribution range 1 extends, for example, from the side edge 116 to the side edge 117. However, the invention is not limited thereto. Refer to FIG. 3. The backlight module 100a in this embodiment is similar to the backlight module 100 shown in FIG. 1, with the main difference being that the distribution range Ala of the backlight module 100a , for example, includes a plurality of unconnected sub-regions A2, and the plurality of sub-regions A2, for example, respectively correspond to a plurality of light-emitting diodes 121. In the width direction D3 parallel to the light exit surface 112 and the light-incident surface 111, the width W2 of each sub-region A2 is more than 1.3 times the width W1 of the light-emitting surface 122 of each light-emitting diode 121, for example, 1.4 times, 1.5 times, 1.6 times, or 1.7 times, which is not specifically limited in the invention. The ratio between the width W2 and the width W1 can be adjusted as needed based on factors such as the spacing between the plurality of light-emitting diodes 121 and the light emission angle of the light-emitting diodes 121.

In an embodiment of the invention, the plurality of columnar structures 113 extends, for example, from the light-incident surface 111 to another surface 115 opposite to the light-incident surface 111, as shown in FIG. 1. In other words, in this embodiment, the region of the light exit surface 112 with the columnar structures 113 may be larger than the distribution range A1, which, however, is not specifically limited in the invention. In another embodiment, the plurality of columnar structures 113b of the light guide plate 110b are, for example, arranged within the distribution range A1 and do not extend beyond the distribution range A1, as shown in FIG. 4. In still another embodiment, the size of a region provided with the columnar structures 113 may be between the distribution range A1 and the range of the light exit surface 112 (not shown in the figure).

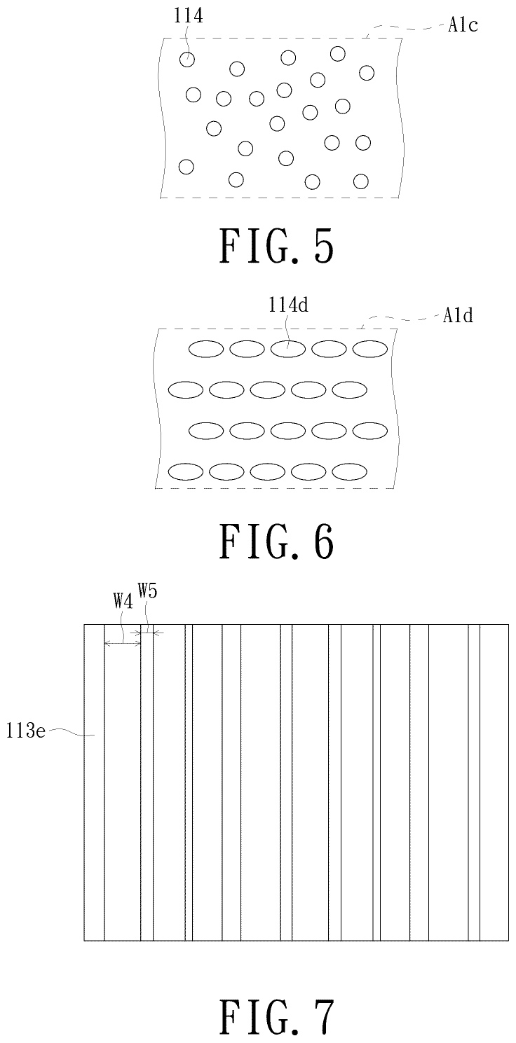

The plurality of point structures 114 in an embodiment of the invention is, for example, distributed regularly or randomly. Specifically, the point structures 114 in FIG. 1 are, for example, regularly distributed within the distribution range A1. The point structures 114 may also be randomly distributed within the distribution range Alc, as shown in FIG. 5, which, however, is not specifically limited in the invention.

In an embodiment of the invention, vertical projections of the plurality of point structures 114 on the light exit surface 112 are in the shape of at least one of a circle or an ellipse. For example, the vertical projection of the point structure 114 in FIG. 1 on the light exit surface 112 is, for example, circular, and the vertical projection of the point structure 114d in FIG. 6 on the light exit surface 112 is, for example, elliptical, which, however, is not specifically limited in the invention. In another embodiment, the shape of the vertical projection of the point structure 114 on the light exit surface 112 may also be of another shape, such as a triangle, polygon, or irregular shape (not shown in the figure).

In an embodiment of the invention, the widths of the plurality of columnar structures 113 are the same or different, where the width of the columnar structure 113 is, for example, the length in the direction (for example, the width direction D3) perpendicular to the extension direction D2 of the columnar structure 113. For example, as shown in FIG. 1, the widths W3 of the plurality of columnar structures 113 are the same. In the embodiment shown in FIG. 7, the widths of the plurality of columnar structures 113e, for example, are different. Specifically, the width W4, for example, is greater than the width W5, which, however, is not specifically limited in the invention. The width of the columnar structure can be adjusted based on actual needs, which is not specifically limited in the invention. It should be noted that the plurality of columnar structures 113 with the same width W3 may be provided with a plurality of point structures 114 distributed regularly, as shown in FIG. 1, or may be provided with a plurality of point structures 114 distributed randomly (not shown in the figure). In addition, the plurality of columnar structures 113e with different widths may be provided with a plurality of point structures 114 distributed regularly (not shown in the figure) or may be provided with a plurality of point structures 114 distributed randomly (not shown in the figure).

In summary, in the invention, a light guide plate, which has a light exit surface provided with a plurality of columnar structures and a plurality of point structures, is used, the plurality of point structures being provided on the plurality of columnar structures. In the length direction, the predetermined length of the distribution range of the plurality point structures accounts for 0.5% to 1.5% of the total length of the light guide plate, and thus the backlight module can provide a surface light source with uniform brightness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module, comprising:
a light guide plate, having a light-incident surface and a light exit surface adjacent to each other, wherein the light exit surface is provided with a plurality of columnar structures, the columnar structures are provided with a plurality of point structures, the point structures are located in a distribution range of the light exit surface, wherein in a length direction intersecting the light-incident surface, the distribution range extends a predetermined length from the light-incident surface in a direction away from the light-incident surface, and the predetermined length accounts for 0.5% to 1.5% of a total length of the light guide plate along the length direction; and
a light source, arranged opposite the light-incident surface.

2. The backlight module according to claim 1, wherein the columnar structures extend from the light-incident surface to another surface opposite to the light-incident surface.

3. The backlight module according to claim 1, wherein the columnar structures are arranged in the distribution range and do not extend out of the distribution range.

4. The backlight module according to claim 1, wherein an extension direction of the columnar structures is perpendicular to the light-incident surface.

5. The backlight module according to claim 1, wherein the light exit surface has two opposite side edges connected to the light-incident surface, and the distribution range extends from one of the two side edges to the other of the two side edges.

6. The backlight module according to claim 1, wherein the light source comprises a plurality of light-emitting diodes, the distribution range comprises a plurality of unconnected sub-regions, and the sub-regions respectively correspond to the light-emitting diodes, wherein in a width direction parallel to the light exit surface and the light-incident surface, a width of each of the sub-regions is more than 1.3 times a width of a light-emitting surface of each of the light-emitting diodes.

7. The backlight module according to claim 1, wherein the point structures are distributed regularly or randomly.

8. The backlight module according to claim 1, wherein the columnar structures have the same or different widths.

9. The backlight module according to claim 1, wherein orthographic projections of the point structures on the light exit surface are in the shape of at least one of a circle or an ellipse.

10. The backlight module according to claim 1, wherein a material of the light guide plate comprises polymethylmethacrylate, polycarbonate, MS resin, or glass.
